(19) United States
(12) Patent Application Publication
(10) Pub. No.: US 2026/0242164 A1
(43) Pub. Date: Aug. 20, 2026

(54) VEHICLE RESTRAINT HAVING A PLURALITY OF BLOCKING POSITIONS FOR RESTRAINING A VEHICLE RELATIVE TO A LOADING DOCK

(71) Applicant: Blue Giant Equipment Corporation, Mississauga (CA)

(72) Inventors: Sharad Jayantilal Vaghasiya, Brampton (CA); Richard Harwart, Bolton (CA); Gerard Biasutto, Woodbridge (CA); Inderpreet Singh, Brampton (CA)

(73) Assignee: Blue Giant Equipment Corporation, Mississauga (CA)

(21) Appl. No.: 19/542,822

(22) Filed: Feb. 18, 2026

Related U.S. Application Data
(60) Provisional application No. 63/760,708, filed on Feb. 20, 2025.

(51) Int. Cl. B65G 69/00

(52) U.S. Cl. CPC B65G 69/003

(57) ABSTRACT

A vehicle restraint for a loading dock includes a barricade member, a locking member, and a barricade motor. The barricade member is rotationally operable between a stored position, a plurality of blocking positions and a verification position. The barricade member includes a receiving surface that defines faces that correspond to the blocking positions. The locking member is rotationally operable between locking and release positions. The locking member is selectively operable to the locking position to engage one of the faces to selectively define a respective blocking position of the blocking positions. The barricade motor selectively activates to rotationally operate the barricade member between the stored, blocking and verification positions. The barricade motor is selectively idle when the locking member is in the locking position and the barricade member is in the respective blocking position. The locking member selectively maintains the barricade member in the respective blocking position.

### CROSS-REFERENCE TO RELATED APPLICATION

This application claims priority to and the benefit under 35 U.S.C. § 119(e) of U.S. Provisional Patent Application No. 63/760,708, filed on Feb. 20, 2025, entitled VEHICLE RESTRAINT HAVING A PLURALITY OF BLOCKING POSITIONS FOR RESTRAINING A VEHICLE RELATIVE TO A LOADING DOCK, the entire disclosure of which is hereby incorporated herein by reference.

### FIELD OF THE DISCLOSURE

The present device is in the field of loading dock assemblies, and more specifically, a vehicle restraint for a loading dock assembly that includes a plurality of blocking positions for securing a vehicle in a parked position relative to a loading dock assembly.

### BACKGROUND OF THE DISCLOSURE

Loading dock assemblies within facilities include various components. These components can include, but are not limited to, vehicle restraints, dock doors, dock levelers, signaling systems, and other similar components. These components are typically operated according to a control panel that provides for operation of these components in a particular sequence and according to various protocols.

### SUMMARY OF THE DISCLOSURE

According to one aspect of the present disclosure, a vehicle restraint for a loading dock includes a barricade member, a locking member, and a barricade motor. The barricade member is rotationally operable between a stored position, a plurality of blocking positions and a verification position. The barricade member includes a receiving surface that defines a plurality of faces that correspond to the plurality of blocking positions. The locking member is rotationally operable between a locking position and a release position. The locking member is selectively operable to the locking position to engage one of the plurality of faces to selectively define a respective blocking position of the plurality of blocking positions. A barricade motor selectively activates to rotationally operate the barricade member between the stored position, the plurality of blocking positions and the verification position. The barricade motor is selectively idle when the locking member is in the locking position and the barricade member is in the respective blocking position. The locking member selectively maintains the barricade member in the respective blocking position.

According to another aspect of the present disclosure, a vehicle restraint for a loading dock includes a barricade member, a barricade motor, and a locking member. The barricade member is rotationally attached to a base and is rotationally operable between a stored position, a plurality of blocking positions, and a verification position. The barricade member has a faceted portion that defines the plurality of blocking positions. The barricade motor selectively activates to rotationally operate the barricade member between the stored position, the plurality of blocking positions, and the verification position. The locking member is operable between a locking position and a release position and is selectively operable to the locking position to engage the faceted portion of the barricade member to define a respective blocking position of the plurality of blocking positions. The barricade motor is selectively idle when the locking member is in the locking position and the barricade member is in the respective blocking position. The locking member selectively maintains the barricade member in the respective blocking position.

According to yet another aspect of the present disclosure, a vehicle restraint includes a barricade member, a barricade motor, and a locking member. The barricade member is rotationally operable relative to a base between a stored position, a plurality of blocking positions, and a verification position. The barricade member has a blocking surface that is configured to engage a vehicle and a faceted portion that defines the plurality of blocking positions. The barricade motor selectively activates to rotationally operate the barricade member between the stored position, the plurality of blocking positions, and the verification position. The locking member is operable between a locking position and a release position to selectively engage a respective face of the faceted portion. The respective face corresponds to a respective blocking position of the plurality of blocking positions. The locking member is selectively operable to the locking position when the verification position of the barricade motor identifies the presence of a vehicle within a parked position. The locking member is operated by a locking actuator that operates the locking member between the locking position and the release position. The barricade motor and the locking actuator are selectively idle when the locking member is in the locking position and the barricade member is in the respective blocking position. The locking member selectively maintains the barricade member in the respective blocking position.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a schematic cross-sectional view of a loading dock assembly showing a vehicle restraint securing a vehicle in a parked position;

FIG. 2 is a schematic diagram illustrating a vehicle restraint showing the barricade member in a first blocking position;

FIG. 3 is a schematic diagram of the vehicle restraint of FIG. 2, and showing the barricade member in a second blocking position;

FIG. 4 is an elevation view of a vehicle restraint and showing operational components of the vehicle restraint;

FIG. 5 is a schematic diagram of the vehicle restraint of FIG. 2, and showing the barricade member in a stored position;

FIG. 6 is a schematic diagram of the vehicle restraint of FIG. 2, and showing movement of the vehicle restraint from a lowered position to a raised position;

FIG. 7 is a schematic diagram of the vehicle restraint of FIG. 2, and showing operation of the barricade member from a verification position to the first blocking position;

FIG. 8 is a schematic diagram of the vehicle restraint, and showing operation of the barricade member to the first blocking position;

FIG. 9 is a schematic diagram of the vehicle restraint of FIG. 2, and showing operation of the barricade member to the second blocking position;

FIG. 10 is a schematic diagram of the vehicle restraint of FIG. 2, and showing operation of the vehicle restraint between the stored position, the verification position, and a plurality of blocking positions; and

FIG. 11 is a schematic diagram illustrating operation of the barricade member in conjunction with the position sensors.

The components in the figures are not necessarily to scale, emphasis instead being placed upon illustrating the principles described herein.

### DETAILED DESCRIPTION

As required, detailed embodiments of the present disclosure are disclosed herein; however, it is to be understood that the disclosed embodiments are merely exemplary of the invention that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present invention.

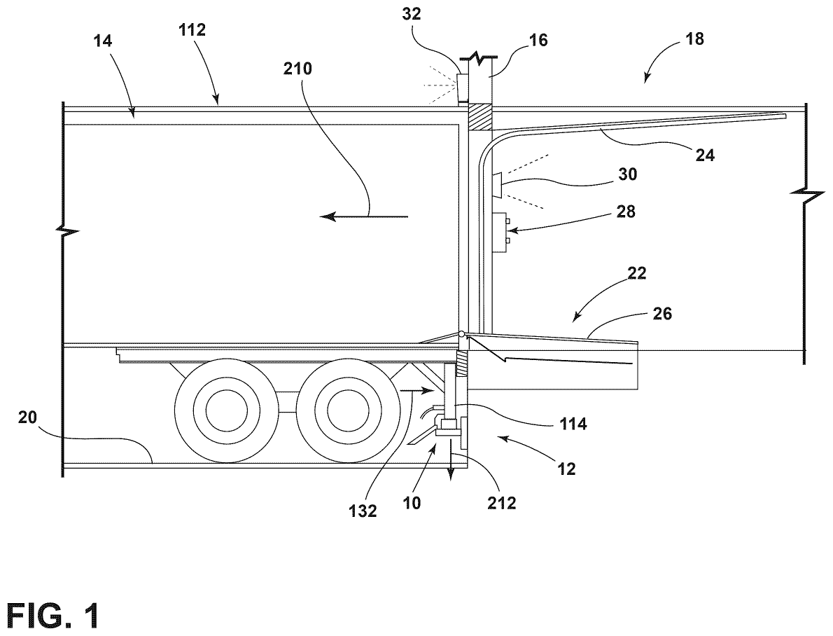

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a vehicle restraint having a plurality of blocking positions for restraining a vehicle relative to a loading dock. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as “first” and “second,” “top” and “bottom,” and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

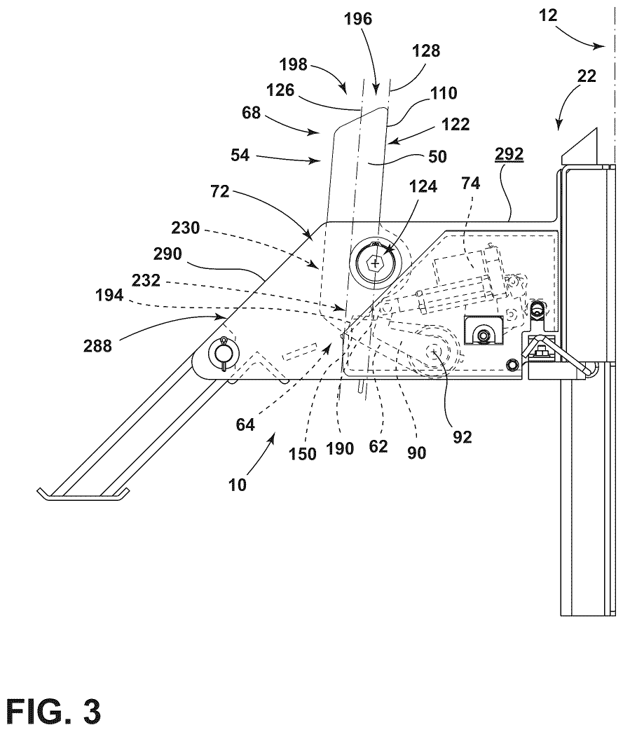

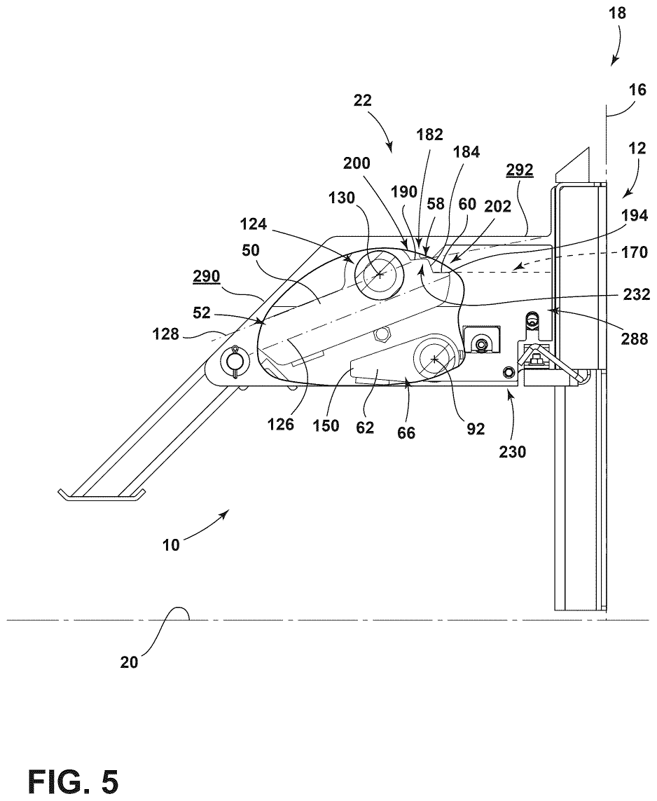

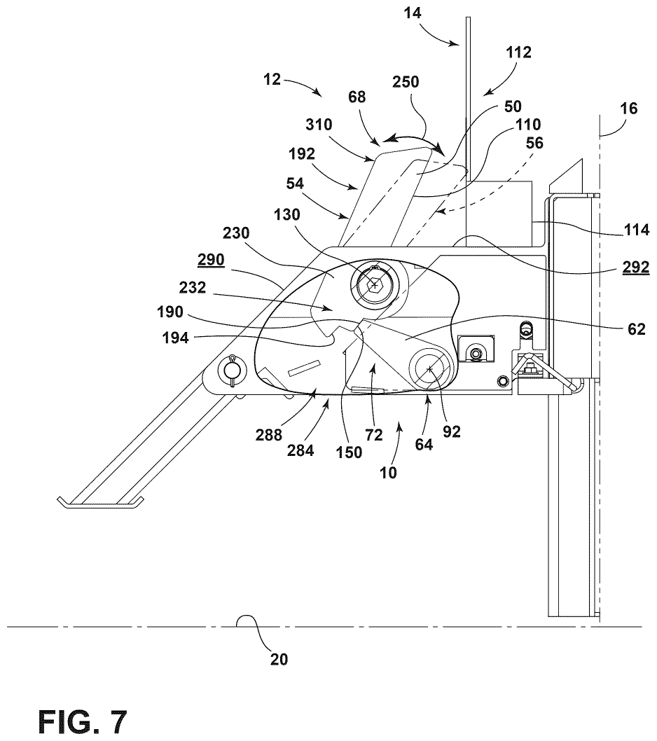

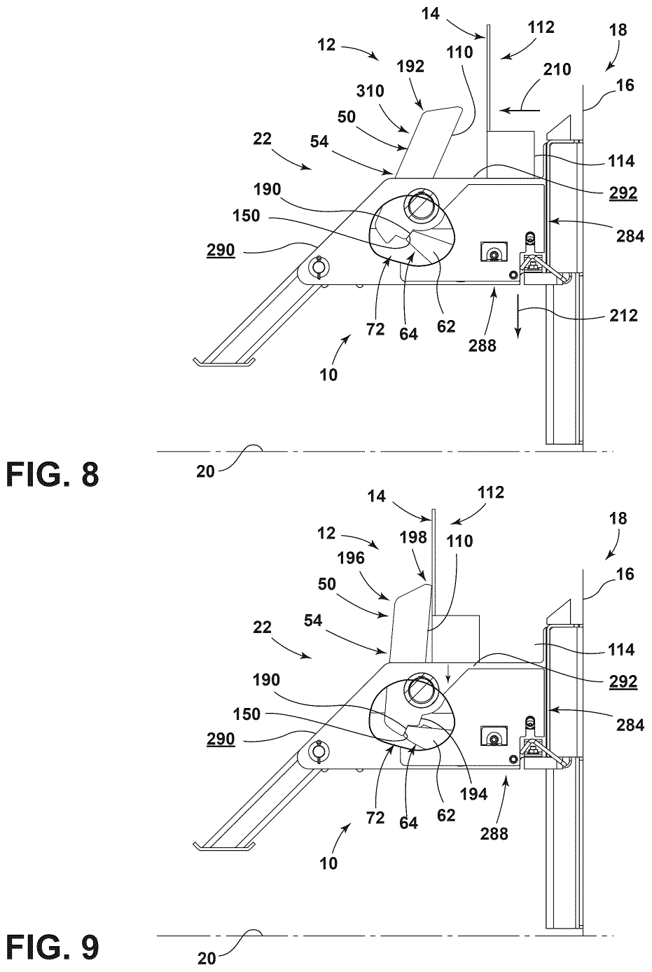

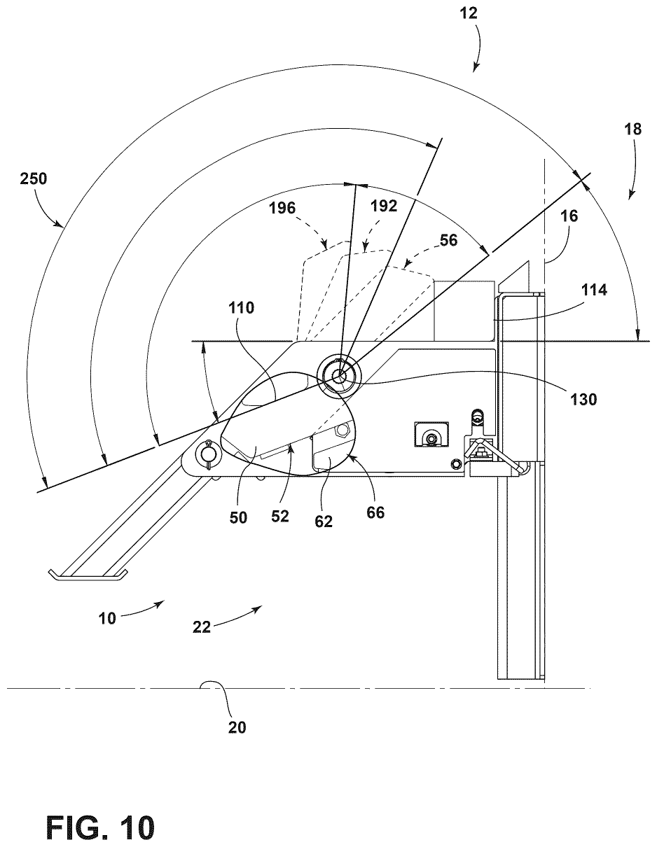

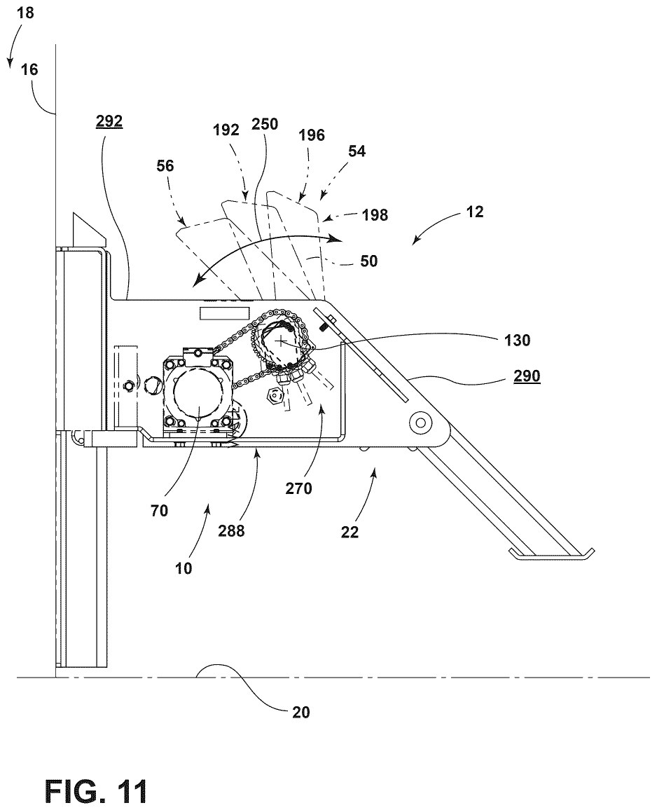

Referring to FIGS. 1-11, reference numeral 10 generally refers to a vehicle restraint that is utilized within a loading dock 12. The vehicle restraint 10 is utilized for restraining a vehicle 14 relative to a wall 16 for a loading facility 18 to prevent inadvertent or unwanted movement of the vehicle 14 away from the loading facility 18. The vehicle restraint 10 is typically attached to a substrate 20, such as a concrete slab or pad, within a loading dock assembly 22. The vehicle restraint 10 can also be attached to the wall 16 of the facility 18, such as a foundation wall or other structural wall of the facility 18. The loading dock assembly 22 includes a door 24 for the loading dock 12 that provides access into the facility 18. The loading dock assembly 22 can also include a dock leveler 26 that extends from the loading dock 12 for the facility 18 into the vehicle 14 for accomplishing various loading and unloading operations. An interior controller 28 is provided within the facility 18 for providing a control interface of the loading dock assembly 22 from within the facility 18. Various internal signals 30 are positioned within the facility 18 and various external signals 32 are positioned outside of the facility 18 for communicating certain information to loading dock staff, the driver, and other individuals and personnel located within the facility 18 and outside of the facility 18. Various controls can also be positioned outside of the facility 18 for allowing limited operation or full operation of components of the loading dock assembly 22 from outside of the facility 18.

Typically, for the safety of the personnel within and around the loading facility 18, control of the loading dock assembly 22 is provided through the interior controller 28. Through this configuration, limited interaction or no interaction is experienced between the loading dock personnel, the vehicle 14, and the moving components of the loading dock assembly 22. In this manner, personnel remain separated a safe distance from the vehicle restraint 10, the dock leveler 26, the door 24, and other similar movable components of the loading dock assembly 22.

Referring again to FIGS. 1-11, the vehicle restraint 10 for the loading dock 12 includes a barricade member 50 that is rotationally operable between a stored position 52, a plurality of blocking positions 54, and a verification position 56. The barricade member 50 includes a receiving surface 58 that defines a plurality of faces 60 that corresponds to the plurality of blocking positions 54. A locking member 62 is rotationally operable between a locking position 64 and a release position 66. The locking member 62 is selectively operable to the locking position 64 to engage one of the plurality of faces 60. This engagement selectively defines a respective blocking position 68 of the plurality of blocking positions 54. A barricade motor 70 selectively activates and rotationally operates the barricade member 50 between the stored position 52, the plurality of blocking positions 54, and the verification position 56. The barricade motor 70 is selectively idle when the locking member 62 is in the locking position 64 and the barricade member 50 is in the respective blocking position 68. The locking member 62 selectively maintains the barricade member 50 in the respective blocking position 68. In this manner, when the barricade member 50 is in the respective blocking position 68, the barricade member 50 and the locking member 62 define a static state 72 such that electrical power is not being delivered to the barricade motor 70 or an actuator 74 that operates the locking member 62.

Referring again to FIGS. 1-11, the actuator 74, such as a linear actuator 74, operates the locking member 62 between the locking position 64 and the release position 66. The linear actuator 74 can be coupled to a linkage 90 that is attached to a locking rotational axis 92 about which locking member 62 rotates. In this manner, operation of the linear actuator 74, via the actuator 74 and the linkage 90, rotates the locking member 62 about the locking rotational axis 92 to define the release position 66 and the locking position 64. It is contemplated that the actuator 74 that operates the locking member 62 can be a linear actuator 74, rotational actuator, combinations thereof, and other similar actuating mechanisms.

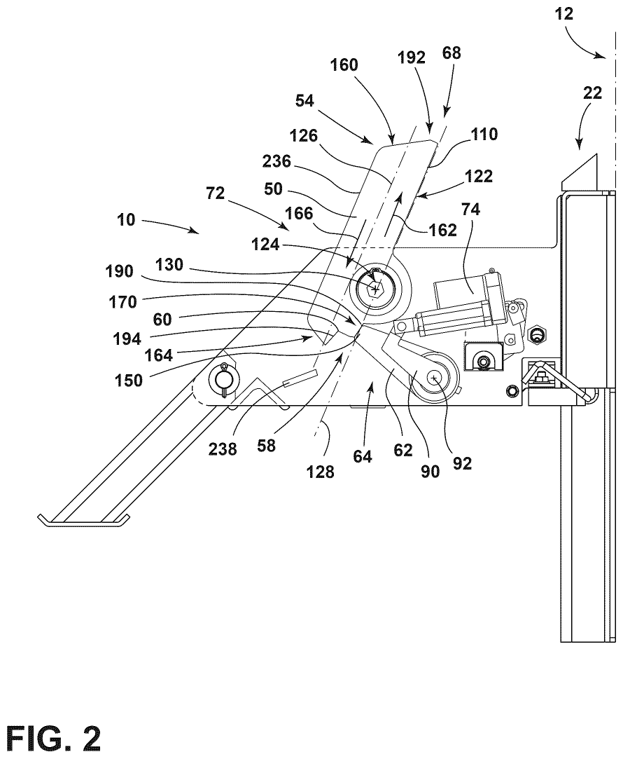

Referring again to FIGS. 2-11, the barricade member 50 includes a blocking surface 110 that is configured to engage the vehicle 14 for restraining the vehicle 14 in a parked position 112 relative to the loading dock 12. The vehicle 14 parked at the loading dock 12 typically includes a rear impact guard bar or “RIG” bar 114, sometimes referred to as an ICC bar. This RIG bar 114 is attached to a frame for the vehicle 14 and provides a robust point for the blocking surface 110 to engage to maintain the vehicle 14 in the parked position 112 relative to the wall 16 of the loading facility 18. The barricade member 50 includes the receiving surface 58 that is adjacent to the blocking surface 110.

Typically, the receiving surface 58 opposes the blocking surface 110 with respect to a barricade rotational axis 130 of the barricade member 50. Stated another way, the receiving surface 58 and the blocking surface 110 are generally on a common side 122 of the barricade member 50 with respect to a central longitudinal axis 126 of the barricade member. Within the common side, the receiving surface 58 is positioned to one side of the barricade rotational axis 130 and the blocking surface 110 to the opposing side of the barricade rotational axis 130. In this configuration, where the blocking surface 110 engages a vehicle 14 and a portion of the receiving surface 58 receives the locking member 62, the forces applied by the vehicle 14 and the locking member 62 are cancelled out. Accordingly, the barricade member 50 is held in a generally static condition where the vehicle 14 engages the blocking surface 110 and the locking member 62 engages a portion of the receiving surface 58. Additionally, it is contemplated that the barricade rotational axis 130 is located in an offset position 124 with respect to the central longitudinal axis 126 of the barricade member 50. In this offset position 124, in certain aspects of the device, the barricade rotational axis 130, the blocking surface 110, and at least a portion of the receiving surface 58 are generally co-linear along a support axis 128 of the barricade member 50. This support axis 128, like the barricade rotational axis 130, is positioned in the offset position 124 with respect to the central longitudinal axis 126 of the barricade member 50.

During operation of the barricade member 50, the barricade member 50 rotationally operates about the barricade rotational axis 130. The barricade member 50 includes a first end 160 that extends from the barricade rotational axis 130 in a first direction 162 generally along the support axis 128. This first end 160 can include the blocking surface 110. The barricade member 50 also includes a second end 164 that extends from the barricade rotational axis 130 in a second direction 166 generally along the support axis 128, wherein the second direction 166 generally opposes the first direction 162. The second end 164 includes a plurality of faces 60 that make up the faceted portion 232. The plurality of faces 60 of the faceted portion 232 can be further characterized as at least one notch 182, and typically a plurality of notches 182, that are defined within an outer surface 184 of the second end 164.

As exemplified in FIGS. 2-11, the barricade member 50 rotates about a barricade rotational axis 130. The blocking surface 110 is positioned to one side of the barricade rotational axis 130. The receiving surface 58 having the plurality of faces 60 that corresponds to the plurality of blocking positions 54 is positioned to the opposing side of the barricade member 50 relative to the barricade rotational axis 130. Accordingly, the blocking surface 110 and the receiving surface 58 are generally positioned to one side, and the same side, of the barricade member 50. Through this configuration, a restraining force 132 that exists between the locking member 62 to the respective face 60 of the receiving surface 58 is positioned generally perpendicular to the face 60 and an engaging end 150 of the locking member 62. This generally perpendicular engagement provides a maximum restraining force 132 that prevents rotation of the barricade member 50 away from the respective blocking position 68. Additionally, through this configuration, the barricade motor 70 and the actuator 74 can be de-energized when the barricade member 50 is in the respective blocking position 68 and the locking member 62 is in the locking position 64. Again, the barricade member 50 and locking member 62 define a static state 72 in this condition, such that electrical power is not needed for maintaining the barricade member 50 in the respective blocking position 68 or for maintaining the vehicle 14 in the parked position 112.

Referring again to FIGS. 2-11, the configuration of the barricade member 50 and the locking member 62 to maintain the vehicle 14 in the parked position 112 while in the static state 72 allows for the barricade motor 70 and the actuator 74 to be of a minimal size and power rating. Because the barricade motor 70 is designed for rotation of the barricade member 50 between the stored position 52, the plurality of blocking positions 54, and the verification position 56, minimal rotational force or torque is required to accomplish this task. No force is needed by the barricade motor 70 for holding the vehicle 14 in the parked position 112. Rather, the force needed for maintaining the vehicle 14 in the parked position 112 is provided through the structural reinforcement and robust connection between the face 60 of the barricade member 50 and the engaging end 150 of the locking member 62. Again, the respective face 60 and the engaging end 150 of the locking member 62 are positioned parallel with one another to form a flush engagement such that a robust connection can be defined between the barricade member 50 and the locking member 62.

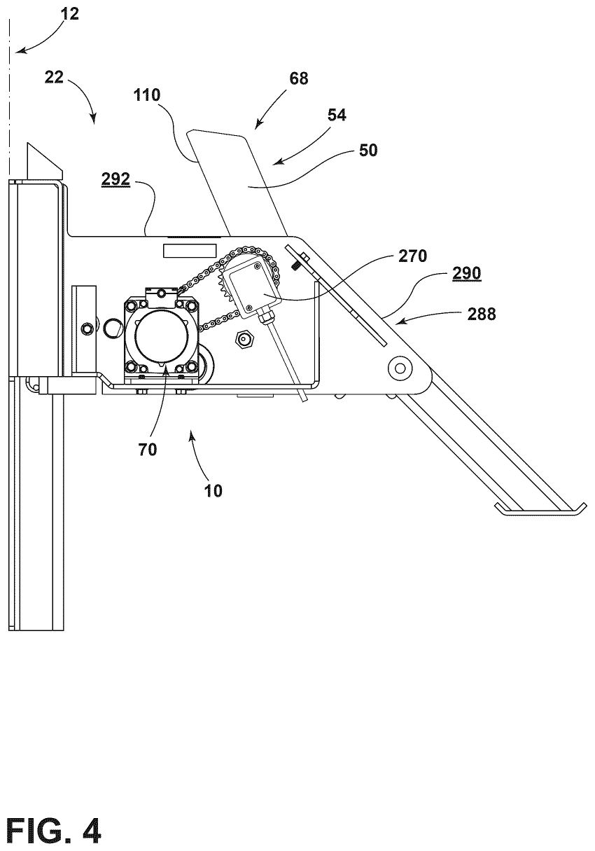

As is illustrated in FIG. 4, the barricade motor 70 for operating the barricade member 50 between the various positions can be a relatively small sized motor that utilizes a chain drive for rotating the barricade member 50 about the barricade rotational axis 130. Similarly, the actuator 74 for rotating the locking member 62 between the locking position 64 and the release position 66 can be sized to have a minimal operating force. Because the actuator 74 is designed for rotating the locking member 62 between the locking position 64 and the release position 66, a minimal size actuator 74 can be utilized for accomplishing this function.

Referring again to FIGS. 2-11, the various faces 60 of the receiving surface 58 are positioned such that when the engaging end 150 of the locking member 62 engages the respective face 60 of receiving surface 58, the engaging end 150 and the respective face 60 are parallel with one another. Accordingly, the various faces 60 of the receiving surface 58 are positioned at a respective angle 170 to achieve this flush and parallel configuration between the engaging end 150 of the locking member 62 and the respective face 60 of the receiving surface 58 for the barricade member 50. In this manner, as the barricade member 50 rotates about the barricade rotational axis 130 between the plurality of blocking positions 54, each respective face 60, being positioned at the respective angle 170, comes into alignment with the engaging end 150 of the locking member 62 as the barricade member 50 moves through each respective blocking position 68. Accordingly, each of the faces 60 of the receiving surface 58 are not oriented parallel with one another. Rather, these faces 60 are positioned at the respective angle 170 to generate the parallel engagement between each respective face 60 and the engaging end 150 as the barricade member 50, and the faces 60 thereof, rotate through the plurality of blocking positions.

As exemplified in FIGS. 2-11, the plurality of faces 60 of the receiving surface 58 includes a first face 190 that corresponds to a first blocking position 192 of the barricade member 50. The receiving surface 58 also includes a second face 194 that corresponds to the second blocking position 196 of the barricade member 50. It is contemplated that the receiving surface 58 can include additional faces 60 that correspond to additional respective blocking positions 54 of the barricade member 50. It is also contemplated that the outermost blocking position 198 can be configured to place the barricade member 50 at a vertical position or nearly vertical position (such as within approximately 1 degree to approximately 10 degrees) with respect to vertical. As described herein, the plurality of faces 60, which includes the first face 190 and the second face 194, can be defined within the plurality of notches 182 that are defined within the outer surface 184 of the second end 164. The plurality of notches 182 can include a first notch 200 that corresponds to the first face 190 and the first blocking position 192 and a second notch 202 that corresponds to the second face 194 and the second blocking position 196.

Where the barricade member 50 rotates farther from the wall 16 of the loading facility 18, beyond vertical, the RIG bar 114 may be able to slide along the blocking surface 110 of the barricade member 50 due to the outwardly angled configuration of the barricade member 50. Accordingly, each of the blocking positions 54 of the barricade member 50 is inclined toward the wall 16 of the loading facility 18 or parallel with the wall 16 of the loading facility 18 in a generally vertical position.

By being inclined toward the wall 16 of the loading facility 18, an outward movement 210 of the vehicle 14 away from the wall 16 causes the interaction between the RIG bar 114 and the blocking surface 110 to generate a downward force 212 that biases the RIG bar 114 toward the substrate 20, thereby further retaining the vehicle 14 in the parked position 112.

Referring again to FIGS. 1-11, the vehicle restraint 10 for the loading facility 18 includes the barricade member 50 that is rotationally attached to a base 230. The barricade member 50 is rotationally operable between the stored position 52, the plurality of blocking positions 54, and the verification position 56. The barricade member 50 includes a faceted portion 232 that defines the plurality of blocking positions 54. The barricade motor 70 selectively activates to rotationally operate the barricade member 50 between the stored position 52, the plurality blocking positions 54, and the verification position 56. The locking member 62 is operable between the locking position 64 and the release position 66. The locking member 62 is selectively operable to the locking position 64 to engage the faceted portion 232 of the barricade member 50 to define a respective blocking position 68 of the plurality of blocking positions 54. The barricade motor 70 is selectively idle when the locking member 62 is in the locking position 64 and the barricade member 50 is in the respective blocking position 68. The locking member 62 selectively maintains the barricade member 50 in the blocking position 54 in a static state 72, where the barricade motor 70 and the actuator 74 for the locking member 62 are deenergized.

As exemplified in FIGS. 2-11, the faceted portion 232 of the barricade member 50 defines the plurality of faces 60 that corresponds to the plurality of blocking positions 54, respectively. The faces 60 that correspond to the plurality of blocking positions 54 are exemplified as being generally flat surfaces. It is contemplated that the engaging end 150 of the locking member 62 and each of the faces 60 of the faceted portion 232 of the barricade member 50, or the receiving surface 58 of the barricade member 50, can include a mating interface to assist in securing the locking member 62 in the locking position 64 relative to a respective face 60 of the barricade member 50. In such an aspect of the device, during operation of the vehicle restraint 10, after the barricade member 50 has moved to the verification position 56 to determine the position of the RIG bar 114, the locking member 62 can be rotated to the locking position 64. Once in the appropriate locking position 64, the barricade member 50 can be rotated away from the RIG bar 114 and into the corresponding blocking position 54 so that the respective face 60 of the barricade member 50 matingly engages the engaging end 150 of the locking member 62.

Typically, the engaging end 150 of the locking member 62 and the respective faces 60 of the receiving surface 58 for the faceted portion 232 are generally flat with respect to one another. Using this configuration, the locking member 62 can be rotated away from the face 60 of the receiving surface 58 when the barricade member 50 is to be moved from the blocking position 54 to the stored position 52 for the vehicle 14 to move away from the parked position 112. In this configuration, the locking member 62 may be moved into and away from the locking position 64 when the barricade member 50 is in the respective blocking position 68. In certain aspects of the device, the stored position 52 can be defined by a resting surface 236 of the barricade member 50 engaging a support member 238 attached to a vertically operable base 230 that generally houses at least the barricade member 50, the locking member 62, and the related operational components thereof. Typically, the resting surface 236 opposes the blocking surface 110 with respect to the central longitudinal axis 126 of the barricade member 50. Accordingly, the resting surface 236, which can also be characterized as a back surface of the barricade member 50, rests on the support member 238 of the base 230.

During operation of the vehicle restraint 10, the vehicle restraint 10 operates from the stored position 52 to the verification position 56. The verification position 56 rotates through a rotational path 250 to engage the RIG bar 114. When the barricade member 50 engages the RIG bar 114, various position sensors 270 detect a vibration, sudden stop, or other interruption of the movement of the barricade member 50 about the barricade rotational axis 130. These movements of the barricade member 50 are sensed through the position sensor 270. Typically the position sensor 270 is a tilt sensor that senses changes in the angular position of the barricade member 50. In this manner, the position sensor 270 can detect minute variations in the angular position of the barricade member 50 that are indicative of vibrations, stops and changes in motion of the barricade member 50. Where the RIG bar 114 is determined to be in an appropriate position, the barricade member 50 then rotates away from the RIG bar 114 to the nearest blocking position 54 of the plurality of blocking positions 54. Once in a corresponding blocking position 54, the locking member 62 rotates, according to the operation of the actuator 74, from the release position 66 to the locking position 64. Once the locking member 62 is in the locking position 64 and the barricade member 50 is in the corresponding blocking position 54, the barricade motor 70 and the actuator 74 are both deenergized to define the static state 72 of the barricade member 50 and locking member 62.

The position sensors 270 used to detect the rotational position of the barricade member 50 and locking member 62 can be in the form of tilt sensors, vibration sensors, rotational motion sensors, and other similar sensors that can be used to detect a rotational position of the barricade member 50 as it moves, or is interrupted, through the rotational path 250 of the barricade member 50. Similar position sensors 270 can be utilized for assessing and determining the rotational position and state of the locking member 62.

It is contemplated that the position sensors 270 can be used in conjunction with the actuator 74 and the barricade motor 70 to learn, or store, certain rotational positions. In this manner, the barricade member 50, in conjunction with the position sensor 270, can verify when the barricade member 50 is in a particular respective blocking position 68, the stored position 52, the verification position 56, or other rotational position therebetween. Interruption of the barricade member 50 through this rotational path 250 can also be measured as being indicative of the barricade member 50 engaging the RIG bar 114 to verify the position of the RIG bar 114 with respect to the wall 16 of the loading facility 18 and the blocking surface 110 of the barricade member 50.

Referring again to FIGS. 1-11, the vehicle restraint 10 includes the barricade member 50 that is rotationally operable relative to the base 230 between the stored position 52, the plurality of blocking positions 54, and the verification position 56. The barricade member 50 includes the blocking surface 110 that is configured to engage the vehicle 14. The barricade member 50 also includes the faceted portion 232, which defines the receiving surface 58, and that defines the plurality of blocking positions 54. The barricade motor 70 selectively activates to rotationally operate the barricade member 50 between the stored position 52, the plurality of blocking positions 54, and the verification position 56. The locking member 62 is operable between the locking position 64 and the release position 66 to selectively engage a respective face 60 of the faceted portion 232 for the barricade member 50. The respective face 60 corresponds to a respective blocking position 68 of the plurality of blocking positions 54.

The locking member 62 is selectively operable to the locking position 64 when the verification position 56 of the barricade motor 70 identifies the presence of the vehicle 14 within the parked position 112. As described herein, this detection is accomplished through the engagement of the barricade member 50, as it moves through a rotational path 250, with the RIG bar 114 of the vehicle 14, or other portion of the vehicle 14. The locking member 62 is operated by the locking actuator 74 that operates the locking member 62 between the locking position 64 and the release position 66. When the barricade member 50 senses the presence of the RIG bar 114 in the appropriate parked position 112, the locking actuator 74 rotates the locking member 62 to the locking position 64. The barricade motor 70 and the locking actuator 74 are selectively idle when the locking member 62 is in the locking position 64 and the barricade member 50 is in a respective blocking position 68. The locking member 62 selectively maintains the barricade member 50 in the blocking position 54 while in a static state 72, as described herein.

According to the various aspects of the device, an excessive torque can be applied to the blocking surface 110 of the barricade member 50 when the vehicle 14 is in the parked position 112. This typically occurs when the vehicle 14 moves away from the wall 16 for the loading facility 18 and engages the barricade member 50. In this engagement, the force of the RIG bar 114 against the blocking surface 110 can generate this excessive torque against the barricade member 50. This excessive torque translates through the barricade member 50, around the barricade rotational axis 130, and into the corresponding face 60 of the receiving surface 58. In this manner, the excessive torque is translated through the corresponding face 60 of the receiving surface 58 and into the engaging end 150 of the locking member 62. This excessive torque can prevent the locking member 62 from rotating away from the locking position 64 due to the presence of the excessive torque. This excessive torque generates a large amount of friction that can prevent the locking member 62 from rotating away from the locking position 64.

Additionally, as described herein, because of the configuration of the locking member 62 and the barricade member 50, the actuator 74 for operating the locking member 62 and the barricade motor 70 for operating the barricade member 50 are low-output motors and actuators that provide a small amount of torque for operating these components. Because of this, these components may not be of the size to overcome the friction generated by the excessive torque that may be present in the system. In this condition, a manual release is installed within the vehicle restraint 10 for moving the locking member 62 away from the face 60 for the barricade member 50. This manual release can be used to move the locking rotational axis 92 in a generally lateral direction to disengage the engaging end 150 from the face 60 of the barricade member 50.

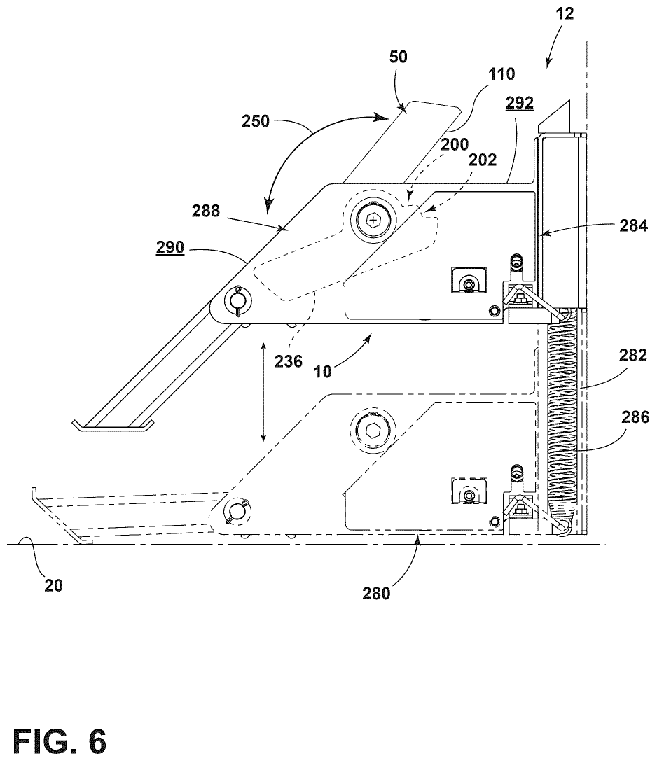

Referring again to FIGS. 2-11, during operation of the vehicle restraint 10, the vehicle restraint 10 may begin in a lowered position 280, as exemplified in FIG. 6, upon approach of the vehicle 14 toward the loading facility 18, the vehicle restraint 10 can translate upward along a track 282 to a raised position 284. This track 282 can include a biasing mechanism 286 that biases the vehicle restraint 10 in an upward direction. The vehicle restraint 10 can include a housing 288 that includes a forward angled surface 290 that can be used to receive the RIG bar 114. Through engagement of the forward angled surface 290 of the housing 288 and the RIG bar 114, the RIG bar 114 can bias the housing 288 in a downward direction, from the raised position 284, to vertically position the housing 288 for the vehicle restraint 10 to receive the RIG bar 114. In this manner, the biasing mechanism 286 that biases the housing 288 in an upward direction is overcome through the engagement of the RIG bar 114 with the housing 288. Through this configuration, the RIG bar 114 can be configured to rest upon a top surface 292 of the housing 288 for the vehicle restraint 10. This configuration also positions the RIG bar 114 in the appropriate vertical position relative to the vehicle restraint 10 to define the parked position 112 of the vehicle 14.

This configuration also positions the RIG bar 114 so that the barricade member 50 can rotate to the verification position 56 to determine the state and position of the RIG bar 114 with respect to the barricade member 50 and the wall 16 of the loading facility 18. As described herein, once the barricade member 50 determines the position of the RIG bar 114, the barricade member 50 rotates away from the verification position 56 to the nearest blocking position 54 or a proximal blocking position 310 away from the RIG bar 114. This proximal blocking position 310 is configured such that no additional blocking positions 54 are defined between the barricade member 50 and the RIG bar 114. Additional blocking positions 54 may be defined farther from the RIG bar 114.

According to the various aspects of the device, the barricade member 50 having the faceted portion 232 defined within the receiving surface 58 defines the plurality of blocking positions 54 for the barricade member 50. Using these plurality of blocking positions 54, the vehicle restraint 10 can be used to secure a vehicle 14 in the parked position 112 in a range of conditions and situations.

By way of example, and not limitation, certain vehicles 14 may include a RIG bar 114 that is damaged, deformed, or otherwise deflected. Use of the barricade member 50 having the plurality of blocking positions 54 can accommodate the damaged or otherwise deformed RIG bar 114 and maintain the vehicle 14 in the parked position 112. Use of the barricade member 50 having the plurality of blocking positions 54 can ensure that the distance between the RIG bar 114 and the receiving surface 58 of the barricade member 50 is kept to a minimal distance. Keeping this distance between the RIG bar 114 and the blocking surface 110 at a minimum ensures a minimal amount of play or idle space between the vehicle 14 and the blocking surface 110 of the barricade member 50. Accordingly, motion of the vehicle 14 is not able to gather a significant amount of momentum for overcoming the restraining force of the vehicle restraint 10.

It will be understood by one having ordinary skill in the art that construction of the described disclosure and other components is not limited to any specific material. Other exemplary embodiments of the disclosure disclosed herein may be formed from a wide variety of materials, unless described otherwise herein.

What is claimed is:

1. A vehicle restraint for a loading facility, the vehicle restraint comprising:
a barricade member that is rotationally operable between a stored position, a plurality of blocking positions, and a verification position, wherein the barricade member includes a receiving surface that defines a plurality of faces that correspond to the plurality of blocking positions;
a locking member that is rotationally operable between a locking position and a release position, wherein the locking member is selectively operable to the locking position to engage one of the plurality of faces to selectively define a respective blocking position of the plurality of blocking positions; and
a barricade motor that selectively activates to rotationally operate the barricade member between the stored position, the plurality of blocking positions, and the verification position, wherein the barricade motor is selectively idle when the locking member is in the locking position and the barricade member is in the respective blocking position, and wherein the locking member selectively maintains the barricade member in the respective blocking position.

2. The vehicle restraint of claim 1, further comprising:
a linear actuator that rotationally operates the locking member between the locking position and the release position.

3. The vehicle restraint of claim 1, wherein the barricade member includes a blocking surface that is configured to engage a vehicle for restraining the vehicle relative to a loading dock, and wherein the receiving surface of the barricade member opposes the blocking surface with respect to a barricade rotational axis of the barricade member.

4. The vehicle restraint of claim 1, wherein the plurality of faces includes a first face and a second face.

5. The vehicle restraint of claim 3, wherein the barricade member operates about a barricade rotational axis, wherein the barricade rotational axis is located in an offset position with respect to a central longitudinal axis of the barricade member.

6. The vehicle restraint of claim 5, wherein the blocking surface, the barricade rotational axis, and the plurality of faces are positioned to a common side of the barricade member relative to the central longitudinal axis.

7. The vehicle restraint of claim 5, wherein an opposing side of the barricade member relative to the central longitudinal axis includes a resting surface, the resting surface engaging a support member to define the stored position.

8. The vehicle restraint of claim 5, wherein the barricade member includes a first end that extends from the barricade rotational axis in a first direction, and wherein the barricade member includes a second end that extends from the barricade rotational axis in a second direction that generally opposes the first direction.

9. The vehicle restraint of claim 8, wherein the plurality of faces are notches that are defined within an outer surface of the second end.

10. The vehicle restraint of claim 5, wherein the barricade member includes a position sensor that detects a rotational position of the barricade member relative to the barricade rotational axis.

11. The vehicle restraint of claim 10, wherein the position sensor further detects vibrations of the barricade member that are indicative of interactions between the barricade member and the vehicle.

12. The vehicle restraint of claim 1, further comprising:
a vertically operable base that houses at least the barricade member.

13. A vehicle restraint for a loading facility, the vehicle restraint comprising:
a barricade member that is rotationally attached to a base, and wherein the barricade member is rotationally operable between a stored position, a plurality of blocking positions, and a verification position, the barricade member having a faceted portion that defines the plurality of blocking positions;
a barricade motor that selectively activates to rotationally operate the barricade member between the stored position, the plurality of blocking positions, and the verification position; and
a locking member that is operable between a locking position and a release position, wherein the locking member is selectively operable to the locking position to engage the faceted portion of the barricade member to define a respective blocking position of the plurality of blocking positions, wherein the barricade motor is selectively idle when the locking member is in the locking position and the barricade member is in the respective blocking position, and wherein the locking member selectively maintains the barricade member in the respective blocking position.

14. The vehicle restraint of claim 13, further comprising:
a linear actuator that operates the locking member about a locking rotational axis between the locking position and the release position.

15. The vehicle restraint of claim 13, wherein a blocking surface that is configured to engage a vehicle for restraining the vehicle relative to a loading dock, and wherein the faceted portion of the barricade member opposes the blocking surface and defines a first notch that corresponds to a first blocking position of the plurality of blocking positions and a second notch that corresponds to a second blocking position of the plurality of blocking positions.

16. The vehicle restraint of claim 15, wherein the barricade member operates about a barricade rotational axis, wherein the barricade rotational axis is located in an offset position with respect to a central longitudinal axis of the barricade member.

17. The vehicle restraint of claim 16, wherein the blocking surface, the barricade rotational axis, and at least one notch of the faceted portion are generally positioned along a support axis that is offset from the central longitudinal axis of the barricade member.

18. A vehicle restraint comprising:
a barricade member that is rotationally operable relative to a base between a stored position, a plurality of blocking positions, and a verification position, the barricade member having a blocking surface that is configured to engage a vehicle and a faceted portion that defines the plurality of blocking positions;
a barricade motor that selectively activates to rotationally operate the barricade member between the stored position, the plurality of blocking positions, and the verification position; and
a locking member that is operable between a locking position and a release position to selectively engage a respective face of the faceted portion, the respective face corresponding to a respective blocking position of the plurality of blocking positions, wherein,
the locking member is selectively operable to the locking position when the verification position of the barricade member identifies the presence of the vehicle within a parked position;
the locking member is operated by a locking actuator that operates the locking member between the locking position and the release position;
the barricade motor and the locking actuator are selectively idle when the locking member is in the locking position and the barricade member is in the respective blocking position; and
the locking member selectively maintains the barricade member in the respective blocking position.

19. The vehicle restraint of claim 18, wherein the blocking surface that is configured to engage the vehicle for restraining the vehicle relative to a loading dock, and wherein the faceted portion of the barricade member opposes the blocking surface and defines a first notch that corresponds to a first blocking position of the plurality of blocking positions and a second notch that corresponds to a second blocking position of the plurality of blocking positions.

20. The vehicle restraint of claim 18, wherein the barricade member operates about a barricade rotational axis, wherein the barricade rotational axis is located in an offset position with respect to a central longitudinal axis of the barricade member.
